(19) United States
(12) Patent Application Publication
(10) Pub. No.: US 2015/0058132 A1
(43) Pub. Date: Feb. 26, 2015

(54) METHODS AND SYSTEMS FOR COLLECTING, CATEGORIZING, AND TARGETING SMS MARKETING RECIPIENTS

(71) Applicant: BLAZONOLOGY LLC, Draper, UT (US)

(72) Inventors: Alma Snowden Tuck, Highland, UT (US); Kent Michael Jones, Highland, UT (US)

(73) Assignee: BLAZONOLOGY LLC, Draper, UT (US)

(21) Appl. No.: 13/991,584

(22) PCT Filed: Apr. 30, 2013
(86) PCT No.: PCT/US13/38907

§ 371 Date: Jun. 4, 2013

Related U.S. Application Data
(60) Provisional application No. 61/642,599, filed on May 4, 2012.

(51) Int. Cl. G06Q 30/02

(52) U.S. Cl. CPC G06Q 30/0269
USPC 705/14.66

(57) ABSTRACT

A computerized system can be configured to gather data about customers and create targeted advertisements. To do so, the system can receive characteristics of a customer that are provided from a source other than the customer, such as another human source located at a point of sale. Additionally, in at least one implementation, a user (e.g., the user at the point-of-sale, an owner of a retail establishment) can create a marketing message that is directed to customers that are associated with specific characteristics.

### CROSS-REFERENCE TO RELATED APPLICATIONS

The present invention is a 35 U.S.C. §371 National Stage of PCT/US13/38907, filed Apr. 30, 2013, which claims the benefit of priority to U.S. Provisional Patent Application No. 61/642,599, filed on May 4, 2012, entitled “Method for Collecting, Categorizing & Targeting SMS Marketing Recipients.” The entire content of each of the aforementioned references is incorporated by reference herein.

### BACKGROUND OF THE INVENTION

1. The Field of the Invention

The present invention relates generally to targeted marketing campaigns.

2. Background and Relevant Technology

Advertising is a multi-billion dollar a year industry. Many companies invest heavily in advertising as a method of increasing their sales. Advertising, however, can be a very expensive undertaking. In particular, paying for advertising within major mediums, such as TV, radio, or internet, can cost a great deal of money.

Because advertising can be so costly, companies generally attempt to target their advertising to particular demographics. For example, during prom season a tuxedo rental shop may want to target its advertising to high school males. In contrast, a luxury car maker may want to target its advertising to middle aged professionals. Accordingly, luxury car advertisements that are read by high school males are likely not going to generate the car maker any additional business. Similarly, it is unlikely that tuxedo rental advertisements read by middle aged professionals are going to generate any additional business for the tuxedo rental shop. One will appreciate that effectively targeted advertisements can provide a much higher return-on-investment than non-targeted broadly sweeping advertisements.

Many forms of targeted advertising currently exist within the market place. For example, television advertising is often priced and sold based upon the demographic that watches a particular show during which advertisements are being sold. Similarly, magazines are often directed towards particular demographics or activities. For example, magazines that discuss outdoor topics are likely ideal places to advertise for companies that deal in outdoor recreation. In contrast, advertising rock climbing equipment within a cooking magazine is not likely to have a high return-on-investment.

One particular form of targeted advertising that is gaining popularity is reward programs. In general, reward programs function by offering customers deals and/or special treatment if they sign-up for the rewards program. By enrolling customers into a rewards program, a company is able to build an in-house database of customer contact information that can be used in advertising. In many cases, these lists can be particularly valuable to a company because the list represents not only customers of the business, but represents customers who expressed a willingness to be contacted regarding sales and specials.

As an example of a conventional rewards program, a clothing store may offer its customers a store specific purchase card or credit card that will automatically give the customer a certain percentage off future purchases. If the customer agrees to join the rewards program, a store employee will often request some form of contact information. This information is entered into a database and is used to communicate future sales and special offers to the customer.

As described above, this conventional method of reward programs based advertising provides several benefits and advantages. In some cases, however, a store may desire to have additional information about a customer that signs up for a rewards program. For example, a store may desire to know the gender, approximate age, and familial status of each customer on the rewards program. This can be beneficial when communicating sales and specials to customers in the rewards program.

For instance, using the clothing store example from above, the store may desire to send out an advertisement regarding a sale of women's swimwear. One will appreciate that the ability to target this advertisement to female members of the rewards program would be beneficial. Sending this advertisement to male members of the rewards program would likely generate little return, and further, could push a male rewards program member to cancel their membership. In many cases, individuals will cancel their membership in rewards programs if they are receiving too many advertisements or if they are receiving advertisements that contain sales that either do not interest them or do not apply to them.

Accordingly, there are a number of problems in the art relating to collecting information about customers and targeting advertisements to those customers that can be addressed.

### BRIEF SUMMARY OF THE INVENTION

Implementations of the present invention overcome one or more problems in the art with systems, methods, and computer program products configured to gather data about customers and create targeted advertisements directed to the customers based upon the gathered data. In particular, one implementation of the present invention receives characteristics of a customer that are provided from a source other than the customer. Additionally, in at least one implementation, a user can create a marketing message that is directed to customers that are associated with specific characteristics.

For example, a method in accordance with at least one implementation of the present invention includes receiving, over a computer network, a unique customer identifier. Additionally, the method can include creating, using a computer processor, a digital customer profile for a customer based upon the unique customer identifier. Further, the method can include receiving, using a computer processor, one or more tags that describe at least one characteristic of the customer. The one or more tags can be provided to the marketing management system by a source that is distinct from the customer. Further, the method can include associating, with a computer processor, the one or more tags with the digital customer profile.

In an additional or alternative implementation, a method for managing a plurality of digital customer profiles can include receiving, over a computer network, a unique customer identifier, wherein the unique customer identifier comprises information sufficient to contact a customer. Additionally, the method can include creating a digital customer profile for the customer based upon the unique customer identifier. The method can also include receiving over a computer network, from an individual that is distinct from the customer, one or more tags that describe at least one visually apparent characteristic of the customer. Further, the method can include associating, with a computer processor, the one or more tags with the digital customer profile. Further still, the method can include generating a marketing campaign that is directed towards one or more customers that are associated with one or more tags of interest.

These and other objects and features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. It should be noted that the figures are not drawn to scale, and that elements of similar structure or function are generally represented by like reference numerals for illustrative purposes throughout the figures. Understanding that these drawings depict only typical embodiments of the invention and are not therefore to be considered to be limiting of its scope, the invention will be described and explained with additional specificity and detail through the use of the accompanying drawings in which:

FIG. 1 illustrates an architectural schematic diagram of a system for managing a plurality of digital customer profiles;

FIG. 2 illustrates an implementation of a point-of-sale interface of the present invention;

FIG. 3 illustrates an implementation of a rewards program marketing interface of the present invention;

FIGS. 4A-4D illustrate implementations of a marketing filter interface of the present invention;

FIG. 5 illustrates an implementation of a reward management interface of the present invention;

FIG. 6 illustrates a flow chart of a series of acts in a method in accordance with an implementation of the present invention for gathering data about customers and creating targeted advertisements directed to the customers based upon the gathered data; and

FIG. 7 illustrates another flow chart of a series of acts in a method in accordance with another implementation of the present invention for gathering data about customers and creating targeted advertisements directed to the customers based upon the gathered data.

### DETAILED DESCRIPTION OF THE PREFERRED EMBODIMENTS

Implementations of the present invention extend to systems, methods, and computer program products configured to gather data about customers and create targeted advertisements directed to the customers based upon the gathered data. In particular, one implementation of the present invention receives characteristics of a customer that are provided from a source other than the customer. Additionally, in at least one implementation, a user can create a marketing message that is directed to customers that are associated with specific characteristics.

One will understand that in many cases a finely targeted advertising campaign can have a significantly higher return-on-investment than an overly broad general advertising campaign. Accordingly, at least one implementation of the present invention can aid in gathering additional information about customers that belong to a rewards program without requiring the customers to personally provide the information.

For example, at least one implementation of the present invention provides an employee with an interface through which the employee can enter visually apparent characteristics of a customer. These characteristics can include, but are not limited to, the customer's gender, the customer's age range, the customer's familial status, the customer's preference regarding the business, etc. This simple information can be gathered and entered by a store employee and then associated with a particular customer profile. Importantly, gathering this information does not require any interaction from the customer but can all be done by an employee at the time the customer signs up for the rewards program.

Additionally, in at least one implementation of the present invention, characteristics of a particular demographic of customers can be programmed into a particular gateway that the customer used to join the rewards program. For example, a Quick Response code (“QR code”) can be created that provides a link to a website through which customers can sign up for the rewards program. The particular QR code can be associated with specific characteristics—for instance, females, 18-30, single. Continuing this example, this QR code can then be placed as advertisements for a rewards program within a frozen yogurt shop of a college town during a ladies night special. In this case, customers that used this particular QR code to sign up for the rewards program are likely single females between 18 and 30 years of age. One will understand that the above is merely exemplary and a similar method could be used to target a variety of different demographics in a variety of different locations and circumstances.

Once a business has associated various characteristics with customers who belong to the business's rewards program, the business can send highly targeted ads to the customers. For example, when the frozen yogurt shop from the above example is having another ladies night, the yogurt shop can target the ads to rewards program members that are single female between the ages of 18 and 30. In contrast, if the business did not have characteristic data associated with its rewards program members, the yogurt shop would have to send out the advertisement to every program member. This could include children and men, to whom the advertisement would clearly not apply.

Various implementations of the present invention can function through a variety of communication media. For example, the present invention can function through any cellular telephone that includes SMS technology. Information can be communicated between the customer and the marketing management system through SMS messaging. For instance, a targeted advertisement can be sent to customers through SMS messaging. In other implementations, the present invention can function through a dedicated smart phone application, a landline telephone number, direct mail, email, or any other common communication medium. Regarding, the land line telephone number, for example, advertisements can be sent to a customer through pre-recorded voice messages.

Accordingly, one will appreciate in view of the specification and claims herein that at least one implementation of the present invention provides the ability to gather characteristic information about customers who belong to a rewards program. Additionally, at least one implementation of the present invention allows a user to create an advertisement that is targeted to rewards program members who are associated with particular characteristics.

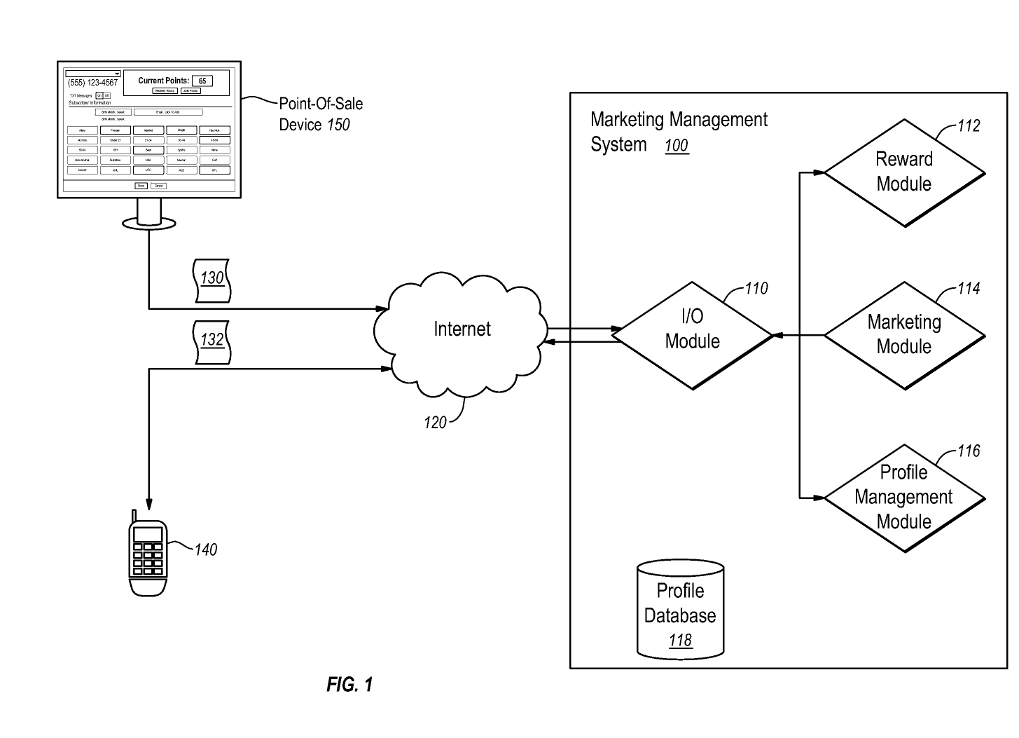

FIG. 1 depicts an architectural schematic diagram of a computer system for managing a plurality of digital customer profiles. The computer system can comprise a marketing management system 100, a point-of-sale device 150, and a cellular telephone 140. In at least one implementation, the recited devices can communicate with each other through the Internet 120 or through some other communication network, such as a cellular telephone network.

The marketing management system 100 can comprise one or more I/O modules 110, one or more reward modules 112, one or more marketing modules 114, one or more profile management modules 116, and one or more profile databases 118. In at least one application, such as described below, these modules and components can be understood as being separate and distinct; however, one will understand that the division of modules is somewhat arbitrary and that implementations of the present invention can be practiced using more modules or fewer modules.

In at least one implementation, when a customer purchases a good or service an employee can ask whether the customer would like to join a rewards program. If the customer expresses an interest to join, the employee can request contact information from the customer. The requested contact information can become a unique customer identifier that for purposes of the marketing management system 100 can be used to identify and track the customer. In at least one implementation, the unique customer identifier can comprise a phone number, an email, an address, or some other form of personal contact information. Additionally, in at least one implementation, a unique customer identifier can comprise a customer account number, loyalty number, account associated card, or some other common method of account association.

Upon entering the customer's contact information (i.e., unique customer identifier) into a point-of-sale device 150, the point-of-sale device 150 can prompt the employee to enter additional information relating to characteristics of the customer. For example, the point-of-sale device 150 can display one or more pre-defined tags that describe characteristics of interest. For instance, the interface may include, among other tags, a tag for male or female, a tag for single or married, a tag for number of children, and a tag for age range.

Using visually apparent characteristics of the customer, the employee can correctly select one or more tags based on observational information alone, and without further querying of the customer. For example, if the customer was a college age man purchasing flowers for his anniversary, the employee could apply the male tag, the married tag, and the tag for the age range of 18-30. The point-of-sale device 150 can then send this information 130 to the marketing management system 100.

In at least one implementation, a picture can be taken of the customer and stored within the profile database. The picture can be later used for identification of the customer, or for the application of tags. For example, if an employee is too busy to enter tags for each new customer, the picture can be accessed later to enter the appropriate tags.

Once the information is received by the I/O module 110 of the marketing management system 100, the I/O module 110 can identify the information 130 as being a new profile and send the profile to the profile management module 116. The profile management module 116 can in turn store the profile in the profile database 118. The stored profile can comprise the unique user identifier (i.e., the customer's contact information) and the tags that were applied by the employee.

In at least one implementation, upon identifying that the information 130 comprises a new rewards program member, the I/O module can send a verification message to the supplied contact information. For example, the I/O module can send an SMS text message to the supplied phone number. The SMS message can include instructions asking the user to send a particular reply to the SMS text to verify the contact information. Similarly, if the user provides a phone number that is not capable of receiving SMS text, the I/O module can send a prerecorded voice message asking the customer to dial a particular number in response to the message to verify the contact information. One will understand that similar methods of verification can be used for email, physical addresses, and other supplied contact information.

In at least one implementation, methods other than point-of-sale entry can be used to initiate a rewards club membership. For example, specific customer characteristics can be associated with a particular method that a customer uses to join the rewards program. For example, the profile management module 116 can be used to create a QR code that provides a link to a website through which customers can sign up for the rewards program. The profile management module 116 can associate specific characteristics with the particular QR code—for instance, gender, age, familial characteristics, etc. The QR code can then be placed as advertisements for a rewards program at a location that is known to be frequented by a particular demographic.

For example, a gym may provide yoga classes for pregnant mothers. Accordingly, the marketing module 114 can be used to create a QR code that is associated with females in the 18-30 age range that have families. The QR code can then be attached to an advertisement that advertises the rewards program and placed around the yoga class. When individuals scan the QR code and sign up for the rewards program by providing their contact information (i.e., unique customer identifier), the profile management module 116 can identify that the new rewards program member signed up using the created QR code. The profile management module 116 can then create a new profile associated with the provided unique customer identifier and associate with that profile a female tag, an 18-30 age group tag, and a family tag. In contrast, if the profile management module 116 determines that the customer is already a member of the rewards program then the profile management module 116 can add a female tag, an 18-30 age group tag, and a family tag to the customer's profile, if those tags were not already associated with the profile.

As an additional example, in at least one implementation, specific tags can be associated with a particular internet landing page. As used in this application, a landing page is a webpage that enables an individual to sign up for the rewards program. Similar to the above example, the profile management module 116 can create a landing page that is associated with specific tags.

For example, the profile management module 116 can create a landing page that is associated with a tag for males and a tag for the age range 50-65. The landing page can then be associated with a link on a webpage that is directed towards financial planning for near-retirement men. Upon receiving a customer's unique customer identifier, the profile management module 116 can create a new profile and associate the above mentioned tags with the profile. The profile can then be saved in the profile database.

Further, in at least one implementation, the specific means that a customer uses to join a rewards program or access the rewards program can be included as a tag within the customer's profile. For example, if a user downloads a mobile telephone app and joins or accesses the rewards program through the app, the profile management module 116 can associate a smart phone tag with the customer's profile. In contrast, if a customer joins the rewards program through email and only accesses the rewards program through email, the profile management module 116 can associate an email tag with the customer's profile.

In at least one implementation, the profile management module 116 can associate with a customer's profile multiple tags relating to how the customer interacts with the rewards program (e.g., both a smart phone tag and an email tag). Later advertisements can then be customized to differentiate between how customers interact with the rewards program.

Additionally, in at least one implementation, the profile management module 116 can gather information about a customer through accessing a GPS unit that is associated with the customer, by automatically accessing various social media websites searching for data that may be associated with a customer, or by sharing and receiving data with other partner businesses. In the case of accessing a GPS Unit, for example, the profile management module 116 can associate tags with the area that the customer frequents. For example, the profile management module 116 may be able to determine where the customer vacations, where the customer lives, where the customer works, etc. One will understand, however, that the above recited description relating to various methods of enrolling customers into a rewards program and associating tags with the customer's profile based upon the method of enrollment are merely exemplary and that a variety of different methods can be used that associate specific tags with a particular method that a customer uses to join the rewards program.

Additionally, in at least one implementation, when the customer purchases a good or service, the transaction information 130 is also sent to the marketing management system 100. In particular, a description or categorization of the service of good purchased and a price of the purchase can be sent to the marketing management system. Upon receiving the information, the I/O module 110 can identify the information as being a transaction and send the information to the reward module 112. The reward module 112 can analyze the purchase and determine if any reward is associated with the purchase.

For example, a particular restaurant may run a promotion that every seventh purchased meal is free. In this case, the reward module 112 can identify whether a meal was purchased and update the customer's reward status accordingly. Once the reward module 112 has analyzed the transaction information 130, the transaction information 130 and any resulting reward can be stored in the profile database 118. In at least one implementation, the transaction information can include a time and date of purchase, a purchase amount, a product purchased, along with other common transactional metrics. One will understand that in order for a customer to receive credit for the purchase of future meals, the customer may be required to provide their unique customer identifier at the time of purchase. Otherwise, an employee may not be able to access the customer's profile.

Additionally, the reward module 112 can also be used to determine when a customer is eligible for a reward. When a customer makes a purchase the point-of-sale machine 150 can communicate the transaction information 130 to the marketing management system 100. The reward module 112 can then access the profile database 118 and determine if the customer is eligible for a reward. For instance, returning to the restaurant example, if the marketing module 112 determines that the customer is eligible for a free meal, the I/O module 110 can communicate that with the point-of-sale device 150. An employee can then ask the customer if the customer desires to redeem the reward.

In at least one implementation, prior to redeeming a reward, the system can require a customer to provide additional identification verification. For example, a unique code can be associated with each profile stored within the profile database 118. The system can then require the customer to provide the unique code in order to redeem the reward. In an alternate implementation, if a customer indicates that he or she would like to redeem the reward, the I/O module 110 can communicate a unique code to the customer through the contact information that is stored within the profile database 118. For example, the I/O module 110 can communicate the unique code to the customer through an SMS message sent to the customer's cellular phone 140. The unique code can likewise be transmitted by the I/O module 110 to the point-of-sale device 150 such that the employee can verify the customer's identity. Additionally, a customer may be able to verify their identity through a rewards program card, picture identification, or some other common method of identification.

The reward module 112 can also be used to notify a customer of their current reward status. In some cases, a reward module 112 may be set to automatically notify a user of their reward status at certain intervals. In other cases, a user can request their reward status from the reward module 112. In at least one implementation, the user can receive an update on their reward status through the Internet, through a dedicated application, through SMS text, through a phone call, through email, or through any other common communication media.

In at least one implementation of the present invention, the marketing management system 100 can also be used to create targeted advertisements. In particular, the marketing module 114 can provide a user with tools to create an advertisement and to target the advertisement to a particular category of the customers within the rewards program. The I/O module 110 can be used to communicate the advertisement to the particular portion of the customers. In particular, the advertisement can be communicated through SMS messaging. One will understand, however, that alternate mediums can be used for advertisements. For instance, an advertisement can be sent through email, through a pre-recorded phone, through mail, through a custom application on smart phones, or through any number of other conventional methods.

As an example of a targeted advertisement, a clothing shop may be having a sale on a particular brand of suit that caters to middle aged men. Accordingly, the marketing module 114 can be used to create an advertisement directed towards all profiles that are tagged as male and as 35-65 years in age. The I/O module 110 can then send an advertisement to each of the customers that have profiles tagged as male and 35-65 years in age. In this way customers who belong to the rewards program are only receiving advertisements that are applicable to them personally.

Additionally, in at least one implementation, the marketing module 114 can use reward information associated with profiles stored within the profile database 118 when sending out advertisements. For example, the marketing module 114 can be used to create an advertisement that is sent to everyone who is eligible for a reward. Using the restaurant example from above, the marketing module 114 can send advertisements notifying qualifying customers that they only need to purchase one additional meal before they receive a free meal.

Further, in at least one implementation, the marketing management system 100 can provide market metrics to a user. In particular, the marketing module 114 can identify various statistics relating sales to the demographics of the rewards program members. For example, the marketing module 114 can be used to identify the days and times that customers fitting within specific demographics tend to make purchases. Additionally, the marketing module 114 can identify which products are purchased by which customers fitting within which demographics. One will understand that because the profile database 118 stores profiles that are associated with demographics and transactional information, the marketing module 114 can gather a wide range of useful statistics.

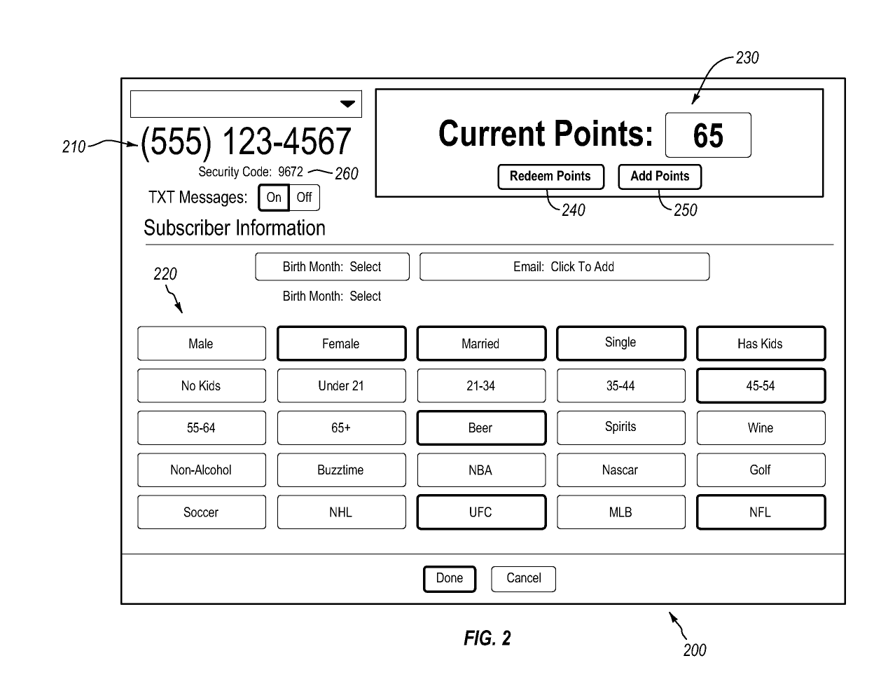

FIG. 2 illustrates an implementation of a point-of-sale interface of the present invention. In this implementation, the point-of-sale interface 200 may be designed for a sports bar. The point-of-sale interface 200 can be displayed on the point-of-sale device 150. In particular, this implementation of the point-of-sale interface 200 can be displayed after an employee enters a customer's unique user identifier 210. In this case, the unique user identifier 210 is the customer's phone number.

Once the point-of-sale interface 200 is displayed, the system can provide an employee with one or more selectable tags 220 that describe various visual characteristics of customers. In the depicted implementation, such tags can include demographical information such as “male,” “female,” “married,” “single,” “has kids,” “no kids,” “under 21,” “21-34,” “35-44,” “45-54,” “55-64,” and “65+.” The depicted tags also include the following tags associated with what the customer is purchasing: “beer,” “spirits,” “wine,” and “non-alcohol.” Additionally, the tags include the following tags associated with the sports being displayed at the sports bar: “NBA,” “Nascar,” “Golf,” “Soccer,” “NHL,” “UFC,” “MLB,” and “NFL.” One will appreciate that the type and format of tags can vary widely from one implementation to the next.

In any event, regarding the demographic information, an employee can gather this information upon visually inspecting the customer. For example, the employee can identify the gender of the customer and identify whether the customer is accompanied by a likely spouse and/or is wearing a wedding ring. Additionally, the employee may note that the customer is wearing a “World's Greatest Dad” shirt and thus identify that the customer has kids.

With respect to the tags that relate to the customer's purchases, the employee can select all of the applicable tags. As explained below, in at least one implementation, this information is automatically provided to the marketing management system 100 in the form of the transaction data 130. However, in at least one implementation an employee may be required to enter this information manually.

In at least one implementation, the transaction data 130 can automatically be analyzed by profile management module 116. The profile management module 116 can mine the transaction data 130 for information of interest and tag the associated customer profile accordingly. For example, a male in the 30-40 age range may purchase two kids meals at a fast food restaurant. Upon analyzing the resulting transaction data 130, the profile management module 116 can determine that a tag for kids should be associated with the customer. As an additional example, a female may rent a particular car from a car rental business. Upon analyzing the resulting transaction data 130, the profile management module 116 can associate a variety of tags with the customer's profile based upon the purchase. For instance, the profile management module 116 may associate tags that relate to the category of car rented, the make of the car, the color of the car, etc.

Returning to the example of the sports bar, the employee can also select all of the applicable tags that relate to the sport that is being displayed within the bar. Additionally, an employee may notice that though multiple sports are playing the customer is particularly interested in Nascar. The employee can then select Nascar instead of selecting every sport that is being displayed. Once the marketing management system 100 has stored these tags within the profile database 118, the marketing module 114 can be used to create an advertisement that is sent to all Nascar fans notifying them of a special Nascar night that the sports bar is hosting.

In at least one implementation, a user can use the profile management module 116 to create custom tags. In the above example of the sports bar, several of the tags were sports related. These tags may not make sense within a shoe store. A user, however, can create custom tags that relate to particular demographics that a user desires to track for the given retail establishment. For example, a clothing store may be more interested in tracking the clothing size of customers. Accordingly, a clothing store can create tags that relate to various clothing sizes.

Additionally, in at least one implementation, an employee can change the tags that were previously associated with a customer. For example, a long-time customer may have joined a customer rewards program when the customer was 16. The customer may still shop at the store years later. An employee may desire to change the tag that is associated with the customer's age from “under 18” to “19-25” (or some other applicable age range). In at least one implementation, to change the tag, the employee can simply select the appropriate age range on the point-of-sale interface 200. The point-of-sale interface 200 can be a smart interface such that it identifies which tags can co-exist and which tags are cannot exist with other particular tags. For example, a customer cannot be both “under 18” and “19-25.” In contrast, a customer can like both NBA and UFC.

In addition to displaying various selectable tags, the point-of-sale interface 200 can also display a variety of information 230 relating to the customer's profile. The information can relate to the purchase history of the customer (e.g., average purchase amount), the current reward status of the customer (e.g., number of points), the currently available rewards, and other applicable information.

Additionally, the point-of-sale interface 200 can provide options to redeem points 240 and options to edit the number of points 250 a customer has earned. In at least one implementation before the number of points can be edited, a manager must first approve the change. As a further security precaution, the point-of-sale interface 200 can also display the unique security code 260 that was describe above as being required to verify the customers identity and can be required from the customer before points can be redeemed.

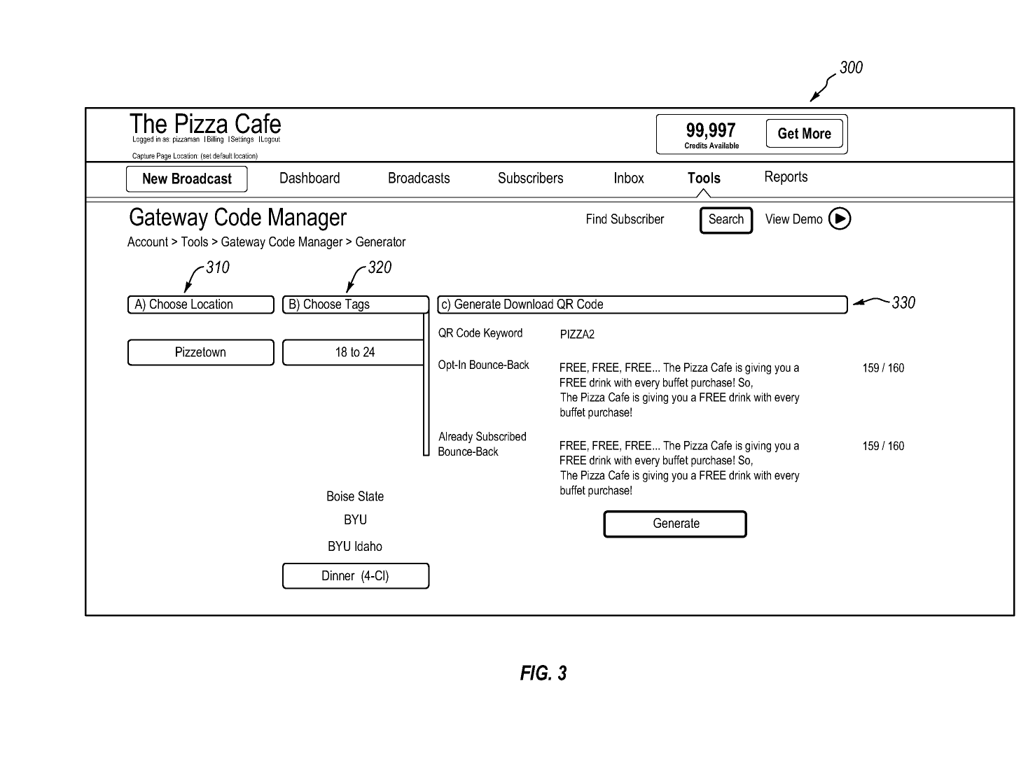

FIG. 3 illustrates an implementation of a rewards program marketing interface 300 of the present invention. The rewards program marketing interface 300 can be used to create advertisements for the rewards program itself. In at least one implementation, therefore, the marketing interface 300 can be in communication with the marketing module 114. For example, the rewards program marketing interface 300 can be used to create the QR code and landing pages described herein, in addition to other applicable advertisements.

The rewards program marketing interface 300 can include a location selection area 310, a tag selection area 320, and an advertisement content area 330. The location selection area 310 can be used to associate the advertisement with a particular business location. For example, a franchise may want to create an advertisement that focuses on only a single location. In another example, a customer may eat at a particular restaurant that is nearby his or her work, but may have a residential address that is closer to another business location. The business may use this information in formulating advertising campaigns directed towards the customer. For example, the business may want to avoid redundant advertisements based upon both locations.

The tag selection area 320 can allow a user to associate particular tags with the advertisement. The advertising content area 330 can allow a user to customize a particular advertisement. For example, the advertising content area 330 can be used to customize an SMS message that can be sent to a customer once they are enrolled in the customer rewards program, or to customize a message that can be sent to customers who are already enrolled within the rewards program.

Returning to the examples from above, the rewards program marketing interface 300 can be used to create a QR code that is directed to females in the 18-30 age range that have families and can be placed within a pregnancy yoga class. Similarly, the rewards program marketing interface 300 can be used to create a landing page that is directed towards males in the age range of 50-65. The landing page can then be associated with a link on a webpage that is directed towards financial planning for near-retirement men. As described above, when a customer signs up to be part of the rewards program through any of the created gateways, the profile management module 116 automatically associates the applicable tags with the user's profile.

In at least one implementation, the rewards program marketing interface 300 can also be used to create a keyword that can be texted by customers to a specific phone number. Similar to the QR code and landing page, the keyword can be associated with specific tags. For example, the marketing module 114 can be used to create a keyword that is associated with tags relating to a particular football team. During a football game where the particular football team is playing, an announcement can be made to text the keyword to a particular number in order to enroll in the customer rewards program and to qualify for a prize.

Customers can then use their cellphones 140 to text the keyword to the particular number. The texts can be communicated to the I/O module 110 and then forwarded to the profile management module 116. Upon receiving the texts, the profile management module 116 can create profiles that are associated with the phone numbers that were used to text the keyword. The profile management module 116 can also associate a tag relating to the football team with each of the new customer profiles. As such, the marketing module 114 can later be used to send advertisements relating to the football team to all rewards program members who are tagged as associating with the football team.

One will understand that using a keyword in this way allows a single phone number to be used with a variety of different keywords. Specifically, a company can use the same phone number for multiple different rewards program advertisement campaigns, each campaign comprising keywords that are associated with unique tags. One benefit of enrolling individuals through SMS texting is that the individual's response automatically includes with itself the individual's phone number.

In at least one implementation, a user who responds to a request to text a keyword, scan a QR code, enter a landing page, or some other marketing method, may already be enrolled into the rewards program. Upon identifying that the user is already enrolled, the profile management module 116 can supplement the user's profile with any new information that was received in the most recent enrollment attempt. For example, a customer who is tagged as a 19-30 year old single female may scan a QR code that is associated with a basketball team. The profile management module 116 can then update the customer's profile to also include a tag associated with the basketball team. Additionally, the profile management module 116 can update a user's profile to include additional unique user identifiers. In particular, the profile management module 116 can merge a loyalty card number, a phone number, an addresses, an email, or another unique identifier into a single account. Similarly, the profile management module 116 can identify that multiple profiles exist that are in fact associated with a single customer. In response, the profile management module 116 can merge the multiple profiles into a single profile that comprises the cumulative unique identifiers, contact information, tags, etc.

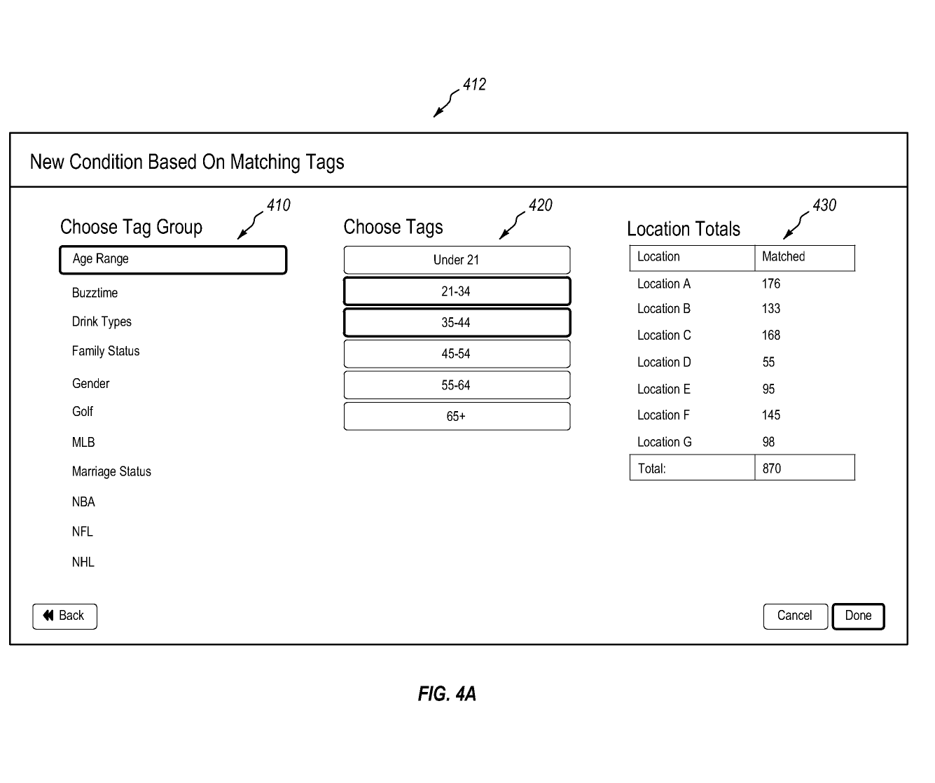

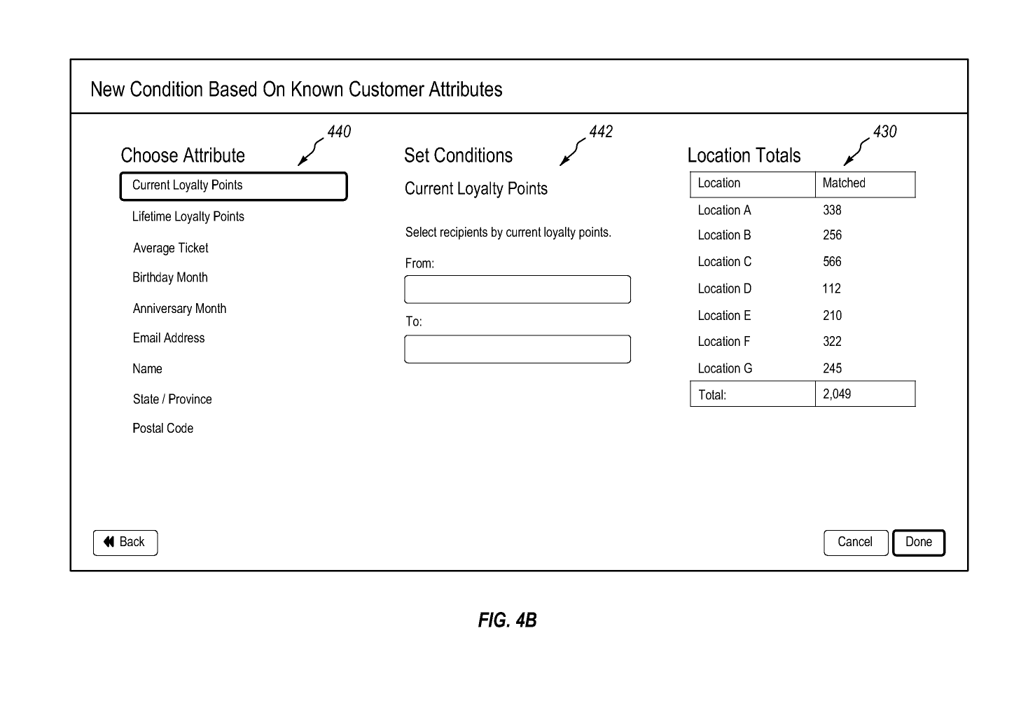

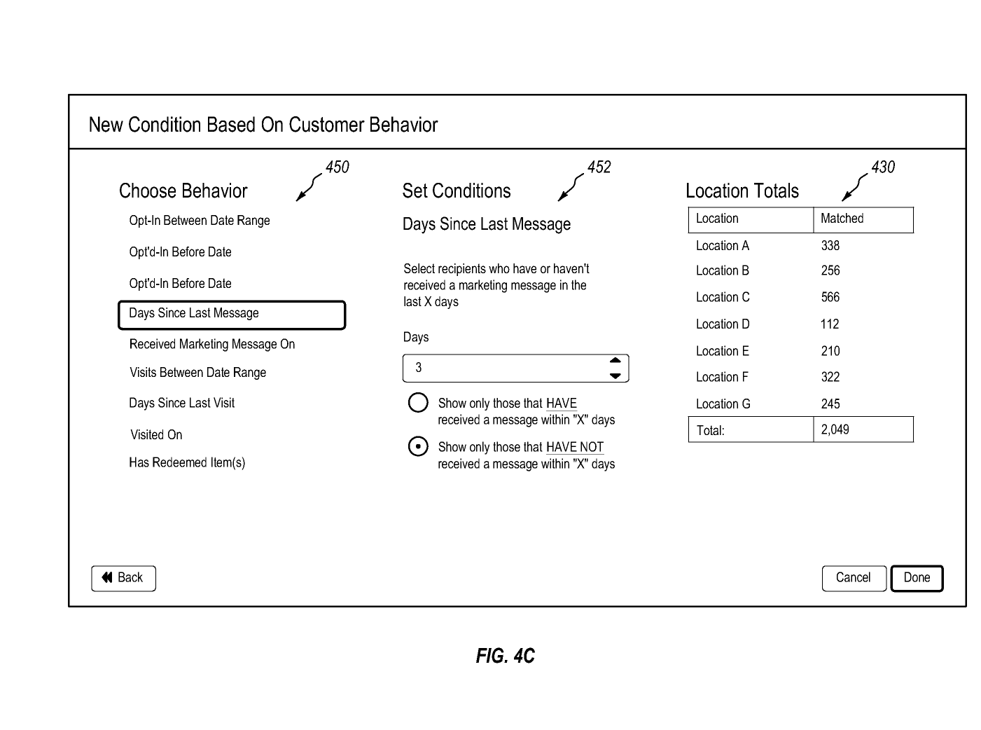

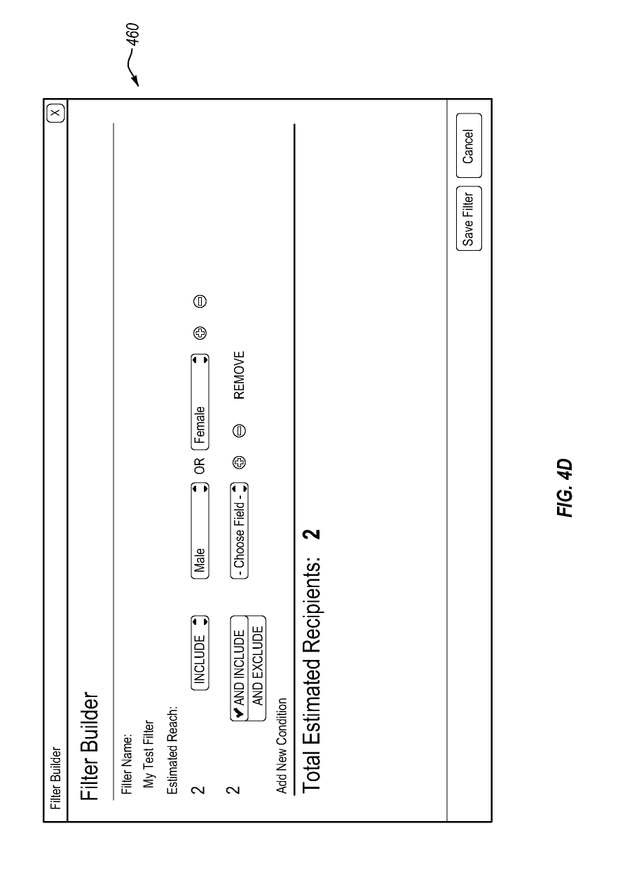

FIG. 4A-4D illustrate implementations of a marketing filter interface of the present invention. For example, FIG. 4A depicts an interface 412 for filtering customers by associated tag. In particular, FIG. 4A shows that the interface 412 displays a selection of tag groups 410, a selection of specific tags 420, and a filter results portion 430. As depicted, the selection of tag groups can include groups such as “Age Range,” “Drink Types,” “Marital Status,” etc. Once a tag group is selected from the selection of specific tags 420, the system can depict the applicable tags. For example, FIG. 4A depicts the particular tags that are associated with age because the “Age Range” group was selected. Additionally, the filter results portion 430 depicts the number of customers that fall within the selected tags.

FIG. 4B depicts an interface for filtering customers by associated attribute. In at least one implementation, attributes can be data that is not visually apparent and thus generally cannot be gathered visually by an employee. In some cases, this data can include information that relates to the transactional information 130 that is sent to the marketing management system 100, such as the average cost of purchases that a customer makes. In contrast, in some cases, attributes can relate to information that is provided directly by the customer, such as a customer's birthdate.

The depicted interface includes a section of attributes 440, a section of attribute conditions 442, and a filter results portion 430. The section of attributes 440 can include attributes such as “Current Loyalty Points,” “Lifetime Loyalty Points,” “Average Purchase Price,” “Birthday Month,” “Anniversary Month,” “Email Address,” “Name,” “State/Province,” “Postal code,” etc. One will appreciate that some of the listed attribute may also qualify as tags. In at least one implementation, the distinction between tags and attributes is at least partially arbitrary, such that a user has complete freedom to create any type of tag and any type of attribute. In general, however, attributes can include information that is calculated over time in relation to the received transactional information 130 and information that is specific to a customer.

In any event, FIG. 4B shows that the selected attribute in this case is Current Loyalty Points. The attribute conditions section 442, in turn, requests that the user enter a particular range of loyalty points. Additionally, the filter results portion 430 depicts the number of customers that fall within the selected attributes. In at least one implementation, a user can use the interface to create filters based upon a one or more attributes and one or more tags.

FIG. 4C depicts an interface for filtering customers by associated behavior. In at least one implementation, behaviors can be data that relate to a customer's purchasing habits, or that relate to marketing that has been directed towards a customer. In some cases, this data can include information that relates to the transactional information 130 that is sent to the marketing management system 100, such as the last time that the customer made a purchase.

The depicted interface includes a section of behaviors 450, a section of behavior conditions 452, and a filter results portion 430. The section of attributes 450 can include attributes such as “Opt'd-in Between Date Range,” “Opt'd-in Before Date,” “Opt'd in After Date,” “Days Since Last Message,” “Received Marketing Message On,” “Visits Between Date Range,” “Days Since Last Visit,” “Visited On,” “Has Redeemed Item(s),” etc. One will appreciate that some of the listed attribute may also qualify as tags or behaviors, and vice-a-versa. In at least one implementation, the distinction between tags, attributes, and behaviors is at least partially arbitrary, such that a user has complete freedom to create any type of tag, any type of attribute, and any type of behavior. In general, however, behaviors can include information that relates to a customer's purchasing habits and/or marketing that has been directed toward a customer.

As depicted, the selected behavior is “Days Since Last Message.” The behavior conditions section 442 can request that the user enter a particular number of days and request that a user specify whether to filter the customers that have received a message within the specified number of days or to filter customers that have not received a message in the specified number of days. Additionally, the filter results portion 430 depicts the number of customers that fall within the selected behaviors. In at least one implementation, a user can use the interface to create filters based upon a one or more attributes, one or more tags, and one or more behaviors.

For example, FIG. 4D depicts an implementation of a filter builder 460. In particular, the depicted filter builder 460 allows a user to apply Boolean logic to create a filter. In at least one implementation, a user can apply Boolean logic to any number of tags, attributes, and behaviors to create a particular filter. For example, a user can create a filter that includes male and female, the age group 20-30 and the age group 30-40, and excludes profiles that are associated with kids. This particular filter may be beneficial for an advertisement that is directed towards single younger adults. Once a user creates a desired filter using any of the method describe above, the user can use the resulting information for market research purposes or for advertising purposes. In the case of market research, the user may be interested in determining how many college age males make purchases between particular hours. One will understand that in at least one implementation using the methods described a user could easily access this information.

In the case of advertising, the user may desire to send a message, such as an SMS text message, to all female customers who have children, spend more than $50 a purchase, and have not received a message in at least two weeks. One will also understand how using the described filtering methods a user can create an appropriate filter and send a targeted advertisement just to the described group.

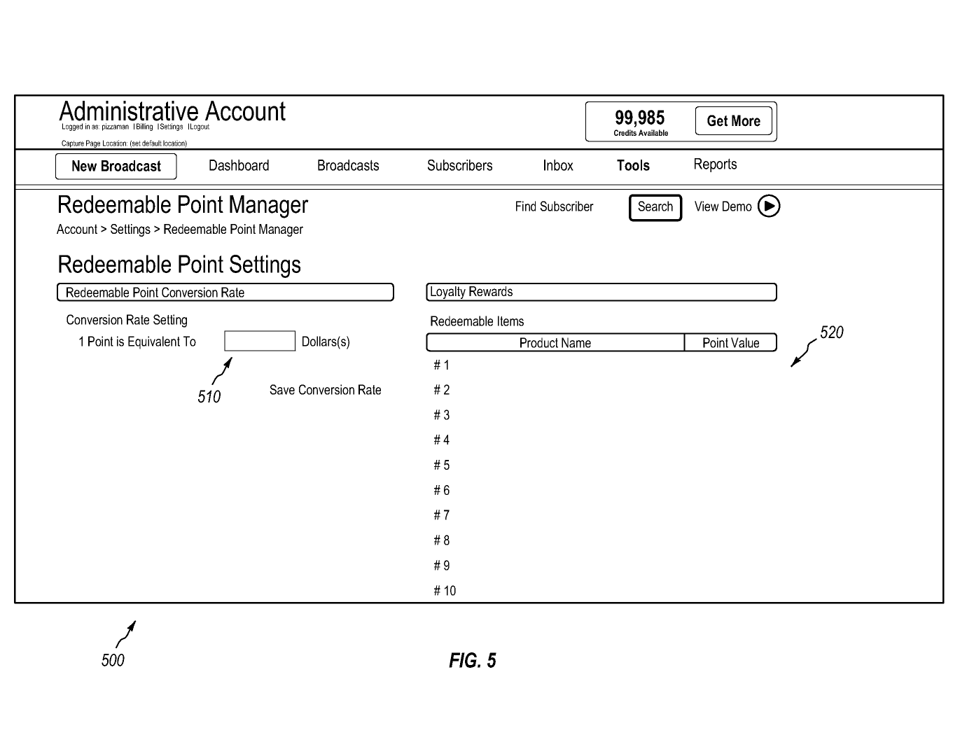

FIG. 5 illustrates an implementation of a reward management interface 500 of the present invention. The reward management interface 500 can allow a user to specify and create a specific loyalty reward program. In the depicted implementation, the reward management interface 500 shows a dollar-to-point conversion section 510. This section can be used to establish a dollar-to-point conversion rate that is associated with points that can be used for purchases. For example, a clothing store owner may determine that a customer can receive five loyalty points for every dollar the customer spends. In at least one implementation, the customer can use accrued loyalty points to make purchases or to receive free items.

In contrast to establishing a conversion rate of point-to-dollar, a user can create a system where accrued points have a specific monetary value when used to purchase goods or services. For example, many airlines provide customers loyalty points based upon how many miles the customer flies with the airline. Using the reward management interface 500, the airlines can establish the value of points when applied to future ticket purchases. For instance, the airline can set a conversion rate of 100 points to every dollar. As such, the customer can buy a $100 dollar ticket with 10,000 points.

In addition to establishing a point conversion rate, the reward management interface 500 can also enable a user to establish specific redeemable items for particular amounts of points. For example, a restaurant that gives customers every tenth meal free can enter into the redeemable item interface 520 that a free meal is equal to nine points, assuming that each purchased meal is worth a single loyalty point.

As an additional example, an electronics store can use the point-to-dollar conversion section 510 to establish a particular number of points that is rewarded based on money spent by the customer. The electronics store can then use the redeemable item interface 520 to specify one or more specific items that are eligible for purchase using loyalty rewards. For example, a pack of batteries may require 500 points, while a particular computer may require 500,000 points.

In at least one implementation, a customer's progress towards loyalty rewards can be used by the marketing module 114 when creating advertisements. For example, the marketing module 114 can determine how far specific customers are from being eligible for a particular redeemable item. The marketing module 114 can then create an advertisement that informs the specific customers about their potential upcoming eligibility for the particular redeemable item. For instance, using the above example, the electronics store can send an advertisement to all customers with over 400,000 points informing them that they only need 100,000 more points for a free computer.

Accordingly, FIGS. 1-5 and the corresponding text illustrate or otherwise describe one or more components, modules, and/or mechanisms for managing a plurality of digital customer profiles. One will appreciate that implementations of the present invention can provide tremendous flexibility and marketing power to a user. In particular, a user can specifically target ads to customers, while avoiding overflowing customers with ads that do not apply.

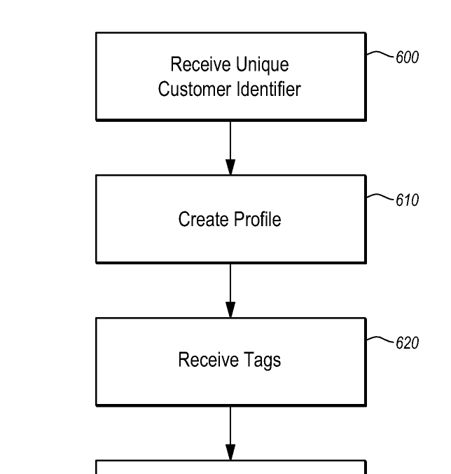

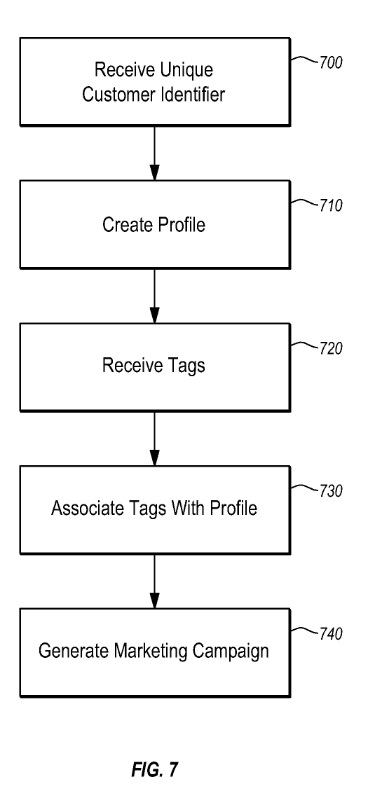

In addition to the foregoing, one will appreciate that implementations of the present invention can also be described in terms of flowcharts comprising a sequence of one or more acts in a method for accomplishing a particular result. For example, FIG. 6 illustrates a method for managing a plurality of digital customer profiles, while FIG. 7 illustrates a method of creating a customer profile. The acts of FIGS. 6 and 7 are described below with respect to the components, modules and diagrams of FIGS. 1-5.

For example, FIG. 6 illustrates that a method for managing a plurality of digital customer profiles can comprise act 600 of receiving a unique customer identifier. Act 600 includes receiving, over a computer network, a unique customer identifier. For example, FIG. 1 shows that a marketing management system 100 can receive a unique customer identifier from a point-of-sale device 150.

FIG. 6 also shows that the method can include act 610 of creating a profile. Act 610 includes creating, using a computer processor, a digital customer profile for a customer based upon the unique customer identifier. For example, FIG. 1 shows that a profile management module 116 can create a digital customer profile based upon a received unique customer identifier.

Additionally, FIG. 6 shows that the method can include act 620 of receiving tags. Act 620 includes receiving, using a computer processor, one or more tags that describe at least one characteristic of the customer, wherein the one or more tags are provided to the marketing management system by a source that is distinct from the customer. For example, FIGS. 1 and 2 show that a marketing management system 100 of the present invention can receive one or more tags from an employee.

Further, FIG. 6 shows that the method can also include act 630 of associating the tags with a profile. Act 630 includes associating, with a computer processor, the one or more tags with the digital customer profile. For example, FIG. 1 shows that the profile management module 116 can associate one or more tags with a digital customer profile.

Additionally, FIG. 7 shows that a method for managing a plurality of digital customer profiles can comprise act 700 of receiving a unique customer identifier. Act 700 includes receiving, over a computer network, a unique customer identifier, wherein the unique customer identifier comprises information sufficient to contact a customer. For example, FIGS. 1 and 2 shows that a marketing management system 100 can receive a phone number (i.e., unique customer identifier) from a point-of-sale device 150.

FIG. 7 also shows that the method can include act 710 of creating a profile. Act 710 includes creating, using a computer processor, a digital customer profile for a customer based upon the unique customer identifier. For example, FIG. 1 shows that a profile management module 116 can create a digital customer profile based upon a received unique customer identifier.

Additionally, FIG. 7 shows that the method can include act 720 of receiving tags. Act 620 includes receiving over a computer network, from an individual that is distinct from the customer, one or more tags that describe at least one visually apparent characteristic of the customer. For example, FIGS. 1 and 2 show that a marketing management system 100 of the present invention can receive one or more tags from an employee that describe a visually apparent characteristic of a customer, such as age or gender.

Further, FIG. 7 shows that the method can also include act 730 of associating the tags with a profile. Act 730 includes associating, with a computer processor, the one or more tags with the digital customer profile. For example, FIG. 1 shows that the profile management module 116 can associate one or more tags with a digital customer profile.

Further still, FIG. 7 shows that the method can include act 740 of generating a marketing campaign. Act 740 includes generating a marketing campaign that is directed towards one or more customers that are associated with one or more tags of interest. FIGS. 1 and 4A-4D show various methods and systems that can be used to create targeted advertisements.

One or more implementations of the present invention allow a user to manage a database of customer profiles. In particular, at least one implementation provides methods for gaining demographic data associated with specific customers without requiring the customers to enter data on their own. Further, at least one implementation allows a user to create advertising messages and campaigns that are directed only towards customers that have specific attributes. One will understand that targeted advertising as provided by the present invention can provide significant returns on advertisement investment.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. In a computerized marketing management system in which a marketing program is loaded into memory and processed at a central processing unit, a computer-implemented method for managing a plurality of digital customer profiles, the method comprising:
receiving, over a computer network, a unique customer identifier;
creating, using a computer processor, a digital customer profile for a customer based upon the unique customer identifier;
receiving without customer input and using a computer processor one or more tags that describe at least one characteristic of the customer, wherein the one or more tags are provided to the marketing management system by a source that is distinct from the customer; and
associating, with a computer processor, the one or more tags with the digital customer profile.

2. The method as recited in claim 1, wherein the at least one characteristic of the customer is visually identified by an individual that is distinct from the customer.

3. The method as recited in claim 1, wherein the unique customer identifier comprises information sufficient to contact the customer.

4. The method as recited in claim 2, wherein the unique customer identifier comprises a phone number.

5. The method as recited in claim 2, wherein the unique customer identifier comprises an email address.

6. The method as recited in claim 1, wherein at least one of the one or more tags comprises a gender of the customer.

7. The method as recited in claim 1, wherein at least one of the one or more tags comprises an age range of the customer.

8. The method as recited in claim 1, wherein at least one of the one or more tags comprises a familial status of the customer.

9. The method as recited in claim 1, further comprising:
receiving an attribute that is associated with the customer, wherein an attribute comprises information about the customer that is not easily visually apparent; and
associating the attribute with the digital customer profile.

10. The method as recited in claim 9, wherein the attribute comprises a birthdate.

11. The method as recited in claim 9, wherein the attribute comprises a name of the customer.

12. The method as recited in claim 1, wherein the digital customer profile is associated with a loyalty reward program.

13. The method as recited in claim 1, further comprising:
receiving from a webpage the unique customer identifier, wherein the webpage is targeted to customers associated with at least one particular characteristic; and
associating with the digital customer profile at least one tag associated with the at least one particular characteristic.

14. The method as recited in claim 1, further comprising:
creating a Quick Response code (“QR code”) that is targeted to individuals associated with at least one particular characteristic, wherein the QR code directs the individuals to a website that requests the unique customer identifier; and
associating with the digital customer profile the one or more tags associated with the at least one particular characteristic.

15. A computer program product for use at a computer system, the computer program product for implementing a method for managing a plurality of digital customer profiles, the computer program product comprising one or more physical storage media having stored thereon computer-executable instructions that, when executed at a processor, cause the computer system to perform the method, including the following:
receiving, over a computer network, a unique customer identifier, wherein the unique customer identifier comprises information sufficient to contact a customer;
creating a digital customer profile for the customer based upon the unique customer identifier;
receiving over a computer network, from an individual that is distinct from the customer, one or more tags that describe at least one visually apparent characteristic of the customer;
associating, with a computer processor, the one or more tags with the digital customer profile; and
generating a marketing campaign that is directed towards one or more customers that are associated with one or more tags of interest.

16. The method as recited in claim 0, wherein the marketing campaign comprises SMS text messages.

17. The method as recited in claim 0, further comprising:
receiving over a computer network information relating to the customer's commercial behavior; and
associating the commercial behavior with the user profile.

18. The method as recited in claim 17, wherein commercial behavior comprises information relating to the shopping habits of the customer.

19. A computer-based system comprising one or more processors configured to execute computer-executable instructions for managing user profiles within a marketing management system, comprising:
receiving over a computer network a unique customer identifier;
creating, using a computer processor, a digital customer profile for a customer based upon the unique customer identifier;
receiving, using a computer processor, one or more tags that describe at least one characteristic of the customer, wherein the one or more tags are provided to the marketing management system by a source that is distinct from the customer; and
associating, with a computer processor, the one or more tags with the digital customer profile.

20. The computer-based system as recited in claim 19, further comprising:
providing to a point-of-sale device instructions to display a plurality of potential tags, where the displayed plurality of potential tags are user selectable;
receiving from a user of the point-of-sale device a selection of at least one of the plurality of potential tags that describes a visually ascertainable characteristic of the customer, wherein the user of the point-of-sale device is distinct from the customer.
